(19) United States
(12) Patent Application Publication
(10) Pub. No.: US 2003/0133151 A1
(43) Pub. Date: Jul. 17, 2003

(54) Print system

(76) Inventors: Yoshiyuki Tamai, Itami-Shi (JP); Tomokazu Kato, Toyokawa-Shi (JP); Takatsugu Kuno, Aichi-Ken (JP)

Correspondence Address: BURNS, DOANE, SWECKER & MATHIS, L.L.P., P.O. Box 1404, Alexandria, VA, 22313-1404, US

(21) Appl. No.: 10/329,479

(22) Filed: Dec. 27, 2002

(30) Foreign Application Priority Data
Dec. 28, 2001 (JP) 2001-401332

(51) Int. Cl. G06F 15/00; B41J 1/00

(52) U.S. Cl. 358/1.15

(57) ABSTRACT

In a print system includes a server holding an application program, in the client computer, when a print request is accepted for data obtained by the application program, an identifier in correspondence to the print request and a request to make print data for the data are sent to the server, while a print request, an identifier in correspondence to the print request, and print control information not dependent on the application program are sent to the printer. In the printer, when the identifier in correspondence to the print request accepted from the client computer is the same as that that received from the server, the print data is printed according to the print control information.

This application is based on application No. 2001-401332 filed in Japan, the contents of which are hereby incorporated by reference.

### BACKGROUND OF THE INVENTION

1. Field of the Invention

The present invention relates to a print system including an application service provider.

2. Description of Prior Art

Recently, a service model called an application service provider (ASP) becomes popular. In a print system using an application service provider, application programs are held in an application server that can be accessed through the Internet. When one of the application programs is needed, a client computer gets the application program from an application server and executes it. Data obtained by the application is sent to and printed by a printer.

When the data obtained by the application program in the application server is printed, the data is converted to a general format such as hypertext markup language (HTML) so that it can be displayed by a browser in the client computer. A printer driver for the client computer receives and converts the data in a print description language (PDL) and sends the PDL data to a printer for the client computer. However, the printer cannot print information that cannot be displayed by the browser. For example, image data having a high resolution may not be printed at the high resolution. Therefore, it is preferable that the application program in the application server generates print data.

Though it is preferable that an application program in the application server generates print data, if the application program is not activated, it cannot make the print data. Therefore, when data obtained by the application program is printed out, a client computer gets the application program from the application server, activates the application program to make print data on the obtained by the application program. Next, a printer driver generates print data and sends it to a printer.

However, it is to be noted that application programs held in the application server include, besides programs such as a word processor or a spreadsheet of smaller data sizes, many management programs not used frequently by a business user such as group wares for personnel management, financial management, data management such as data warehouse, of larger data sizes. Then, if such an application program of larger data size is acquired by a client computer only for printing the data, it will take a long time for the processing and a longer time until the print out thereof. Further, it is a problem that the client computer is not freed for a long time for getting the application program and for sending the print data to a printer. Further, the processing load in the application server increases due to increase in transmission times because for each printing the application program is sent to a client and sent back just after the print data is generated. Further, because a printer has a status varying with time, printing may not be possible when a print job is received. For example, if many print jobs are reserved, when a new job is transmitted, a print out may not be possible. This is ascribable to an error status or a status when another print job from a different client computer is being received. In such a case, when the application server accesses the printer though the Internet, the printer cannot accepts the print job, so that it may reject to receive the job. This is an unproductive access from the application server.

In order to solve these problems, it may be suggested to generate print data in the application server and send it to a printer. However, a printer has information on the configuration thereof inherent for each setting site such as default paper cassette, available paper sizes, discharge option and the like. In a network environment wherein the application server and a printer communicate through the Internet, the application server does not know the above-mentioned configuration information on the printer for the client. Thus, it is difficult to generate control information in correspondence to the configuration information on the printer (not dependent on the application program). Further, print control information according to the printer configuration information may be set for each client. For example, as to a printer wherein a print of 1,200 dots per inch (dpi) can be outputted, a client may set print mode at 600 dpi as default mode, but another client may set print mode of 400 dpi as default mode. If print control information such as output resolution is different when an application program generates print data, it is a problem that print data cannot be generated according to the print control information requested by the client.

A solution may be proposed to upload a printer driver to an application server, which uses the printer driver to convert the data of the application program to print data of a page description language. However, in this case, it takes a long time from a print instruction to start of printing. Further, information not dependent on the application program is also set by the server, and it takes a long time to upload it by a printer driver.

### SUMMARY OF THE INVENTION

An object of the present invention is to perform printing in a network environment including an application service provider efficiently.

In one aspect of the invention, a print system includes a server holding an application program, a client system and a printer are connected through a network. In the client computer, when a print request for data obtained by the application program held in the server is accepted, an identifier in correspondence to the print request and a request to make print data for the data are sent to the server, while a print request, an identifier in correspondence to the print request, and print control information not dependent on the application program are sent to the printer. In the printer, the identifier in correspondence to the print request and the print control information not dependent on the application program are received from the client computer, while the identifier in correspondence to the print request and the print data are received from the server. When the identifier in correspondence to the print request accepted from the client computer is the same as that that accepted from the server, the print data is printed according to the print control information.

In another aspect of the invention, in a printer connected through a network to a client computer and to a server holding an application program, an identifier in correspondence to a print request and control information not dependent on the application program held in the server are received from the client computer, while an identifier in correspondence to the print request and print data are received from the server. When the identifier received from said client computer is the same as that received from the server, the print data received from the server is printed according to the print control information not dependent on the application program.

An advantage of the present invention is that printing can be performed efficiently.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is block diagram of a system including an application service provider;

FIG. 2 is a block diagram of an application server;

FIG. 3 is a block diagram of a client computer;

FIG. 4 is a block diagram of a printer controller;

FIG. 5 is a sequence chart in the system;

FIG. 6 is a flowchart of the application server;

FIG. 7 is a flowchart of the client computer;

FIG. 8 is a flowchart of a network printer; and

FIG. 9 is a flowchart of processing jobs simultaneously.

### DETAILED DESCRIPTION OF THE PREFERRED EMBODIMENTS

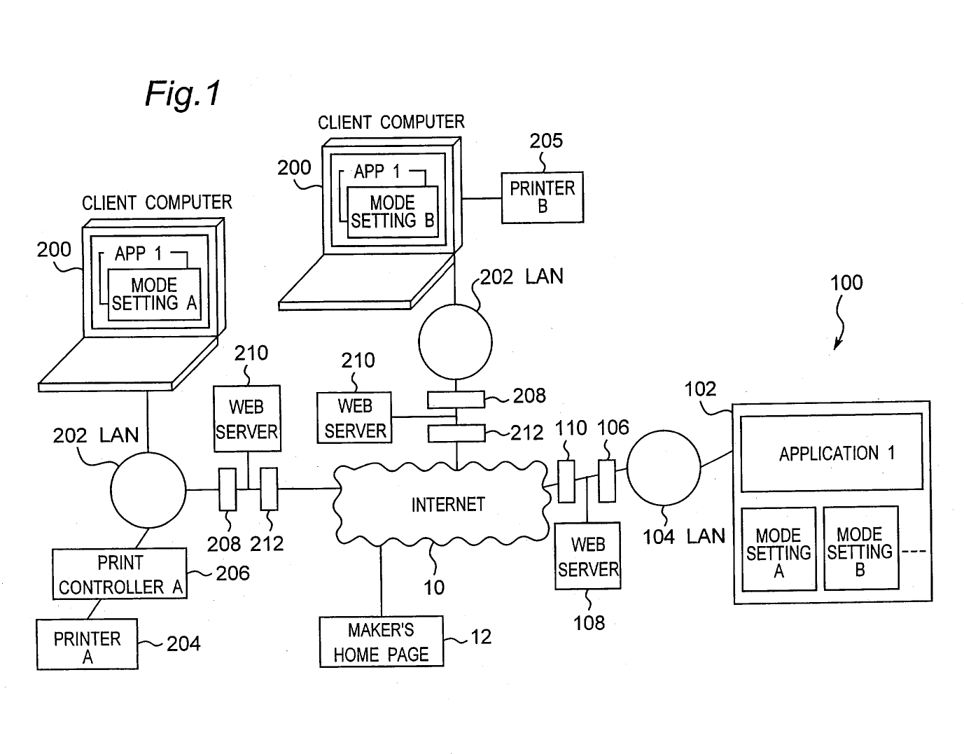

Referring now to the drawings, wherein like reference characters designate like or corresponding parts throughout the several views, FIG. 1 shows a system including an application service provider (ASP) 100, which is connected to a client computer 200 through the Internet. The application service provider 100 includes an application program. A client computer 200 can request the application service provider 100 to provide print data by executing the application program. The obtained data is printed by a printer 204. Though many client computers 200 can be connected to the application service provider 100, but for the simplicity of explanation, only one client computer 200 is shown in FIG. 1.

This system is explained further in detail. The application service provider 100 includes a computer as an application server 102. In order to communicate with the client computer 200 or a printer controller 206, the application server 102 is connected through a local area network (LAN) 104, a fire wall device 106 and a router 110 to the Internet 10. Further, a web server 108 in the application service provider receives an access request to the application server 102 from a client computer 200 and executes a requested service.

When print data is sent, the application server 102 converts the print data obtained by the application program to a printer language and sends the converted print data to a printer controller 206 in the client side directly or through a client computer 200. In this type of printing, a program on mode setting and a user interface are changed for each user or for each client computer.

On the other hand, in the client system, one or more client computers 200 are connected through LAN 202 to the print controller 206, which is connected to the printer 204. The printer controller 206 accepts a print request from a client computer 200. It also receives print data from the application server 102 and sends the received print data to the printer 204. The printer 204, having a printer engine and a controller therefor, prints print data received from the print controller 206. It is to be noted that the printer 204 may be a printer integrated with a print controller.

The client computer 200 and the printer controller 206 are connected through LAN 202 and further through a fire wall device 208, a web server 210 and a router 212 to the Internet 10. The fire wall device 208 has functions such as packet filtering and proxy and passes only packets that satisfy predetermined conditions on IP address of mail source (host name), IP address of destination (host name), port number of sender, port number of destination and data. Thus, only such packets are sent through the Internet to the printer controller 206. In a transmission from an intranet to the Internet or in an access from a printer in the intranet to an application server, a reply transmission is permitted when signals are transmitted from the application server to the printer. The router 212 controls routing.

In the system shown in FIG. 1, the application server 102 provides application programs in parallel according to requests from client computers 200. Further, data obtained by the application programs are stored for each of the users or client computers 200. Further, printer drivers for converting data obtained by the application programs to print data are uploaded to the server 102 for each of the users or client computers 200. The server 102 converts the data of the application to the print data with a printer driver.

The application server 102 converts the data obtained by the application program to print data of a page description language (PDL), and the printer receives the PDL data for printing. In this embodiment, control information dependent on the application program is instructed by the application server, while that not dependent on the application program is instructed by the client computer. The printer receives the control information dependent on the application program and that not dependent on the application program from the different apparatuses, merges them within the printer, and outputs one print job.

The “control information dependent on the application program” means control information that does not affect the output of print data when the application data is converted to the print data. Therefore, it includes control data not used in the generation or the conversion of the print data in the application server, such as color, font size, resolution, number of copies, discharge site and electronic watermark. It also includes control data not used by the application in the server for making or converting print data.

A printer driver to be sent to the server has only a program for making print data from the application data. It is also proposed to send the configuration information of a printer to the application server, and the application server sends control information according to the configuration information to the printer. However, this technique has low communication efficiency because the printer is usually in the same local area network. Therefore, it is preferable to send only control information necessary to make print data of the application data to the application server, and it is not necessary to send the other information. Further, the control information generated according to the configuration information of the printer does not depend on the application program. Therefore, even if it is stored in the application server, it is not used frequently in the application server, while it decreases the resources of the application server. A printer driver has a part for generating control information according to the configuration information of the printer and another part which makes print data such as PDL data interpretable by the printer. Because the former part has a large data size, if it is installed in the application server, it may decrease the resources of the application server. Then, it is preferable to send only control information necessary to make print data from application data and not to send the other information.

A printer driver usually generates not only image information, but also printer control information and page control information, but in this embodiment the client computer does not send control information not dependent on the application program to the server. Therefore, the printer driver does not generate printer control information and page control information, while the printer generates them. That is, functions of the printer driver are limited, and an upload time therefor becomes shorter. The printer prints the received print data according to the generated printer control information and page control information. The job control information includes control information on the printer in the unit of job such as job identifier, job name (application file name), name of job sender, a number of copies and a job processing mode (priority job, non-priority job, synthesis of jobs, division of a job or the like). The page control information includes control information for printing print data on a sheet of paper such as document identifier, document name, double-side printing, paper size, selected paper cassette, paper discharge mode, resolution, gradation or the like.

When the application data is printed in the system wherein the server holds application programs, if compared with a prior art system where the client receives an application program and sends print data to a printer, the transmission of the application program is omitted and a time until start of printing can be shortened. Further, because the client sends control information for printing, not dependent on the application program to the printer, upload of the control information from the client to the server or the like can also be omitted.

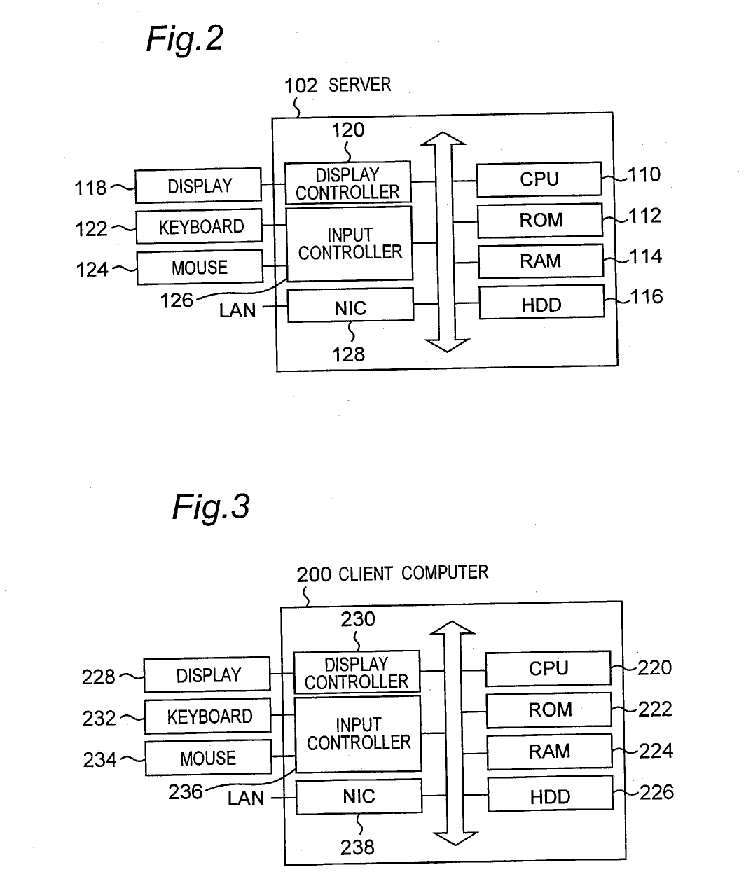

The apparatuses included in the above-mentioned system are explained below in detail. FIG. 2 shows a structure of a computer as the application server 102 provided in the application service provider. The application server 102 has a central processing unit (CPU) 110, a read only memory (ROM) 112, a random access memory (RAM) 114 and a hard disk drive 116, and it is also connected through a display controller 120 to a display device 118 and through input controllers 126 to a keyboard 122 and to a mouse 124. Further, it is connected to a network interface card 128 for data transmission through LAN 104. The hard disk drive 116 stores registered information of client computers 200 including identification data for access for client computers 200 to the application server 102, e-mail addresses of client computers 200, files of application names and application data, addresses of printers used by clients, model names of printers, and names of printer drivers. Further, it stores application programs, application data and printer drivers activated by a print request from a client and different for each client. The registered information of the client computer 200 is stored in folders (or directories) in the hard disk drive 116 so that it can be rewritten and read easily.

In the application server 102, a printer driver makes print job data for application data obtained by application programs. When a print request is accepted from a client computer 200 through the Internet 10, a printer driver is activated to make print data with print image data described in a page description language (PDL). The print data is sent to a printer designated by the client computer 200. Generally a plurality of page description languages are used, but a page description language that can be interpreted by the printer controller 206 is used.

The printer driver makes print data that can be interpreted by the printer controller. When the printer driver is activated, a user interface for operation is displayed in a screen of the display device 118. A request from the client computer 200 is accepted through the Internet, and the application data is converted to print image data of a page description language, so that the application data stored by the application program are converted to data that can be interpreted by the printer controller 206. The printer driver issues a request of print job to a printer designated by the client computer 200 and sends the print data.

FIG. 3 shows a client computer 200. The client computer 200 has a central processing unit (CPU) 220, a read only memory (ROM) 222, a random access memory (RAM) 224 and a hard disk drive 226, and it is also connected through a display controller 230 to a display device 228 and through input controllers 236 to a keyboard 232 and to a mouse 234. Further, it is connected to a network interface card 238 for transmission of data through LAN 202. The ROM 222 and the hard disk drive 226 store a program for access to the application server, a program for obtaining an application program and application data from the application server, a program for requesting to make print data to the application server, and a printer driver. The ROM 222 and the hard disk drive 224 also store an e-mail address (URL) of the application server and identification data for access to the application server.

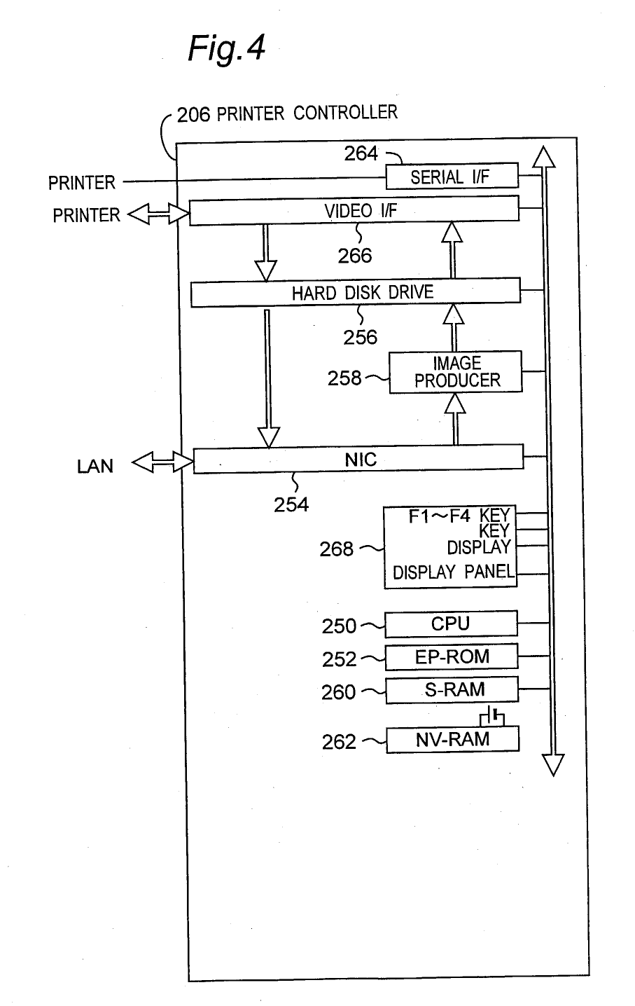

FIG. 4 shows the printer controller 206. In the printer controller 206, a central processing unit (CPU) 250 receives print jobs from the client computers 200, manages the jobs, manages a firmware or ROM, manages image processing of print images, converts data of image information received with an e-mail, converts data of image information to be sent with an e-mail, and manages rewrite of the firmware. An electrically programmable ROM (non-volatile memory) 252 stores control programs for the above-mentioned processings. A network interface card 254 sends and receives various data through LAN, such as print jobs from the client computers 200 and image information to other printers. A hard disk drive (non-volatile memory) 256 stores print jobs received from the client computers 200 and jobs for sending image information. In an image producer 258, an interpreter converts the print data of a print job described in a page description language to intermediate codes, a font memory stores font information and font data for analyzing the intermediate codes, a random access memory (RAM) stores bit map data derived from the intermediate codes, and an image processor sends the bit map data to the RAM. A static random access memory 260 is used as a work area. A non-volatile random access memory 262 back-upped with a battery stores various setting values and management information. The non-volatile memory 262 stores an e-mail address (URL) and a password besides IP address thereof. The printer controller 206 is further connected through a serial interface 264 and a video interface to a serial interface and a video interface of the printer. Further, the printer controller 206 has an operation panel 268 for various operations.

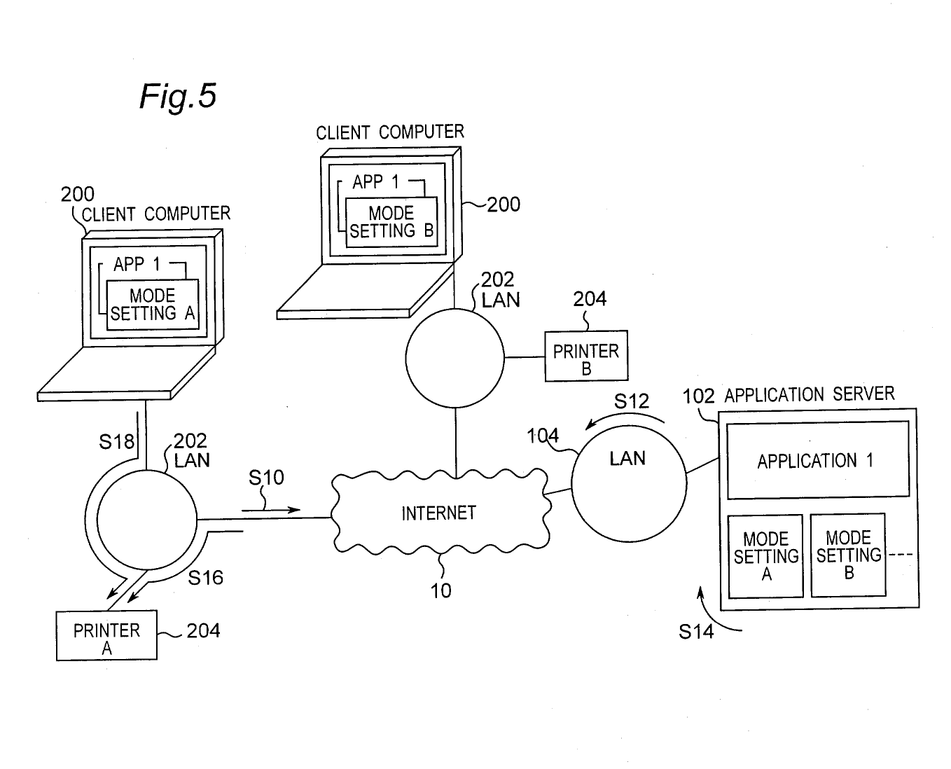

FIG. 5 shows data transmission when data obtained by an application program provided as an application service from the application server 102 is transmitted between a client computer 200 and the application server 102 according to a print request. First, a client computer 200 requests a print to the application server 102 (S10). The application server 102 requests the client computer 200 to send data not dependent on the application program to a printer 204 (S12). The application program makes data dependent on the application program and sends it to the printer (S14). On the other hand, the client computer 200 sends the data not dependent on the application program to the printer 204 (S16). The printer 204 receives and prints the data.

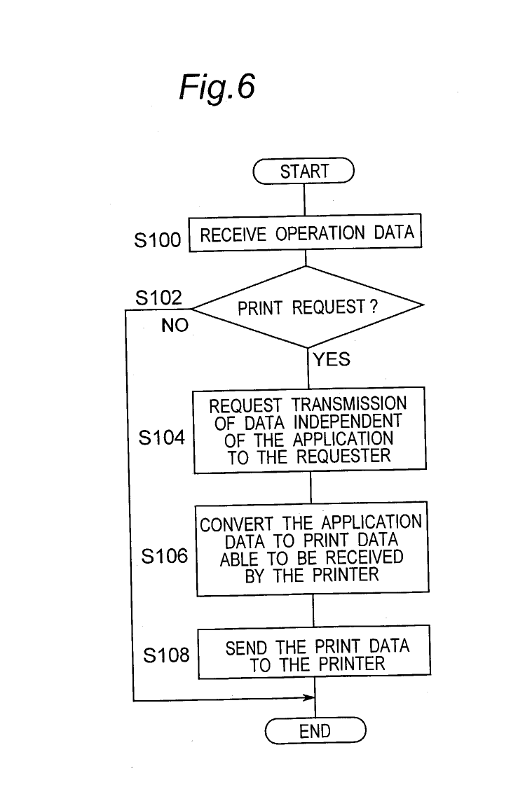

FIG. 6 shows a flow in the application server 102. First, operation information according to an operation by a user is received from a client computer (S100). If the operation information is a print request (YES at step S102), a job identifier is sent to the client computer, and it is instructed to send information not dependent on the application program in the print job information to the printer (S104). Then, the client computer sends the information not dependent on the application program in the print job information as well as the job identifier received from the server. Next, the received application data is converted with the printer driver to data for the network printer (S106), and the same identifier as the identifier sent to the client computer is added and the data is sent to the network printer (S108).

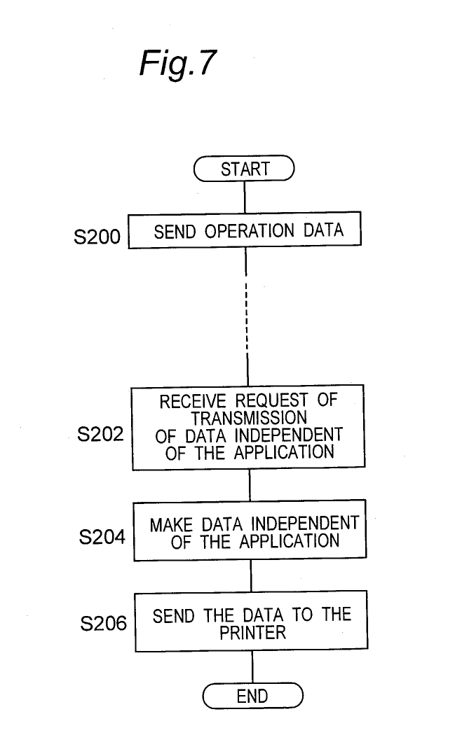

FIG. 7 is a flowchart of a client computer 200. First, operation information is sent according to an operation by a user (S200). The operation data includes a print request to the application server for printing at a network printer. When a print request is sent, a job identifier is received from the server (S202). Next, if it is instructed by the server to send information not dependent on the application program in the print job information (S204), information not dependent on the application program in the print job information as well as the job identifier are made (S206) and sent to the printer (S208) The information not dependent on the application program may be information inputted by a user.

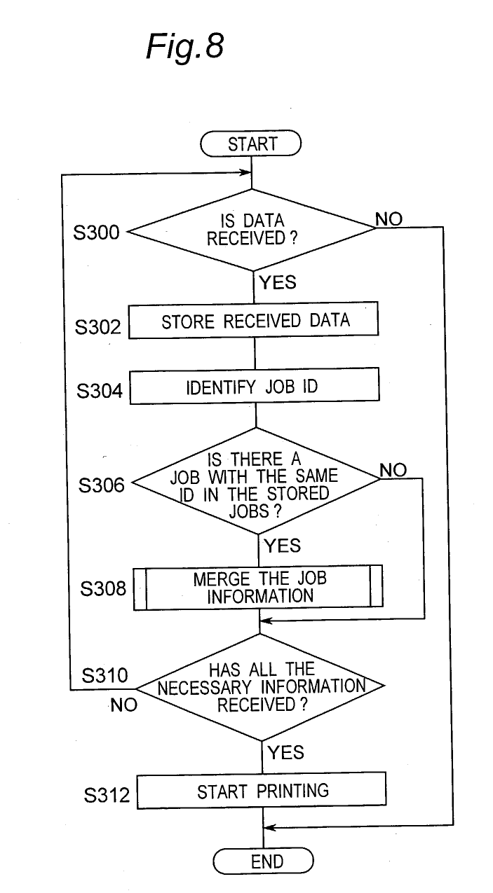

FIG. 8 shows a flowchart of a network printer. When data including information to be printed is received (YES at S300), the data is stored (S302). Next, a job identifier included in the stored data is recognized (S304), and information having the same job identifier is searched in the information stored already (S306). If the information having the same job identifier is found, the newly received and stored information is added to the information stored already (S308). If there is information having the same attribute as the already stored information, but having a different parameter, the parameter is replaced. Next, it is checked whether or not all the necessary information for printing is received (S310). If all the necessary information for printing has been received, printing is started (S312), otherwise the flow returns to step S200.

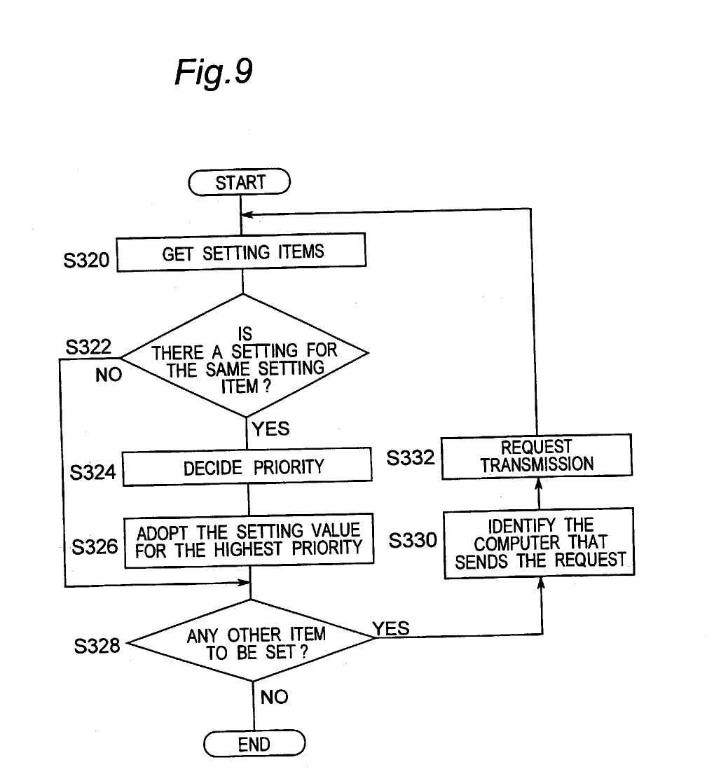

FIG. 9 shows a flowchart of the job information merging (FIG. 7, S308). Data including information to be printed has been received and stored. First, setting items (including the job identifier) included in the stored information is recognized (D320). Next, information having the same job identifier is searched in the information already received and stored (S322) If the information having the same job identifier is found, the newly received and stored information is added thereto. Then, priority is decided (S324), and a setting value for the highest priority is adopted (S326). For example, if there is information having the same attribute as the already stored information, but having a different parameter, the parameter is replaced. Next, it is checked whether or not all the necessary information for printing is included in the stored information (S328). If not included, an identifier of a computer which would have the insufficient information is read in the stored information (S330), and the insufficient information is requested to be sent (S322). Then, the flow returns to step S320.

The embodiments explained above have following advantages.

In a system wherein a server holds application programs, when data obtained by one of the application programs is printed, if compared with a system wherein the application program is received by a client computer and the client computer sends print data to a printer, (1) it can be omitted to send the application program to the client computer, so that a time until a print out can be shortened. Further, (2) because print control information not dependent on the application program is sent from the client computer to the printer for printing, it can also be omitted to upload the print control information from the client computer to the server.

Because information not dependent on the application program is set by a client computer, the function of the print driver is limited, and an upload time of the printer driver is shortened.

In a network environment wherein a printer belongs to the same local area network as a client computer and the server and the printer communicate through the Internet with each other, the server does not know the configuration of the printer such as priority paper cassette or the like. Thus, it is difficult for the server to generate control information independent of the application program. On the contrary, in a network environment of the invention, printing is possible according to the control information based on the printer configuration information.

In the print system disclosed in Japanese Patent laid open Publication 2000-353059, print data received is divided to an image and the other. The image is stored in a folder, and a link data to the folder and the other data are sent to a printer. The printer gets and prints the image data from the folder. In this system, one print data is divided into to image data and the other. Though this system does not include an application service provider, it is similar to the invention in a sense that the print data is divided into two parts. In the invention, the data dependent on an application and that not dependent thereon are dealt, but they are provided from different computers.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A print system wherein a server holding an application program, a client system and a printer are connected through a network;
wherein said client computer comprises:
a receiver which accepts a print request for data obtained by the application program held in said server; and
a sender which, when the print request is accepted, sends an identifier in correspondence to the print request and a request to make print data for the data obtained by the application program to said server and sends a print request, an identifier in correspondence to the print request, and print control information not dependent on the application program to said printer; and
wherein said printer comprises:
a receiver which receives the identifier in correspondence to the print request and the print control information not dependent on the application program from said client computer and receives the identifier in correspondence to the print request and the print data from said server;
a comparator which compares the identifier in correspondence to the print request received from said client computer and that received from said server; and
an image forming unit which, when the identifier in correspondence to the print request received from said client computer is the same as that received from said server, prints the print data received from said server according to the print control information not dependent on the application program.

2. The print system according to claim 1, wherein said sender in said client computer further sends a printer driver to said server, the printer driver comprises a program part only making the print data from the data obtained by the application.

3. A computer connectable through a network to a server holding an application program and to a printer, comprising:
a receiver which accepts a print request for data obtained by the application program held in said server; and
a sender which, when the print request is accepted, sends an identifier in correspondence to the print request and a request to make print data for the data obtained by the application program to said server and sends a print request, an identifier in correspondence to the print request, and print control information not dependent on the application program to said printer.

4. The computer according to claim 3, wherein said sender computer further sends a printer driver to said server, the printer driver comprises a program part only making the print data from the data obtained by the application.

5. A program for image processing executable by a computer connected through a network to a server holding an application program and to a printer, the program comprising the steps of:
accepting a print request for data obtained by the application program held in the server; and
when the print request is accepted, sending an identifier in correspondence to the print request and a request to make print data for the data obtained by the application program to said server, and sending a print request, an identifier in correspondence to the print request, and print control information not dependent on the application program to the printer.

6. The program according to claim 5, wherein in said sending step, further sending a printer driver to the server, the printer driver comprises a program part only making the print data from the data obtained by the application program.

7. A storage medium storing a program executable by a computer connected through a network to a server holding an application program and to a printer, the program comprising the steps of:
accepting a print request for data obtained by the application program held in the server; and
when the print request is accepted, sending an identifier in correspondence to the print request and a request to make print data for the data obtained by the application program to said server, and sending a print request, an identifier in correspondence to the print request, and print control information not dependent on the application program to the printer.

8. A printer connected through a network to a client computer and to a server holding an application program, comprising:
a first receiver which receives an identifier in correspondence to a print request and control information not dependent on the application program held in the server from the client computer;
a second receiver which receives an identifier in correspondence to the print request and print data from the server;
a comparator which compares the identifier received from the client computer and that received from the server; and
a print unit which prints the print data received from the server according to the print control information not dependent on the application program when the identifier received from said client computer is the same as that received from the server.

9. The printer according to claim 9, wherein the printer exists in the same local area network as the client computer, and the printer communicate through a fire wall device and the Internet to the server.

10. A program for image processing executable by a computer connected through a network to a server holding application programs, the program comprising the steps of:
receiving an identifier in correspondence to a print request and control information not dependent on the application program held in the server from the client computer;
receiving an identifier in correspondence to the print request and print data from the server;
comparing the identifier received from the client computer and that received from the server; and
printing the print data received from the server according to the print control information not dependent on the application program received from the client computer when the identifier received from said client computer is the same as that received from the server.

11. The program according to claim 10, wherein the step of printing further comprising the step of deciding which control information has a priority when a plurality of control information not dependent on the application program exist in correspondence to the same identifier, and in said step of printing, the print data is printed according to the print control information having the priority.

12. The program according to claim 10, wherein in the step of printing, when the print control information not dependent on the application program is not received, the print data is printed according to a default print control information.

13. A storage medium storing a program executable by a computer connected to a network and holding application programs, the program comprising the steps of:
receiving an identifier in correspondence to a print request and control information not dependent on the application program held in the server from the client computer;
receiving an identifier in correspondence to the print request and print data from the server;
comparing the identifier received from the client computer and that received from the server; and
printing the print data received from the server according to the print control information not dependent on the application program received from the client computer when the identifier received from said client computer is the same as that received from the server.
